(19) United States
(12) Patent Application Publication
(10) Pub. No.: US 2019/0043034 A1
(43) Pub. Date: Feb. 7, 2019

(54) METHOD AND SYSTEM FOR RECEIVING A DEBT PAYMENT

(71) Applicant: CREDIT CLEAR INTERNATIONAL PTY LTD, Victoria (AU)

(72) Inventor: Trent MCKENDRICK, Victoria (AU)

(21) Appl. No.: 16/076,725

(22) PCT Filed: Feb. 10, 2016
(86) PCT No.: PCT/AU2016/000035

§ 371 Date: Aug. 9, 2018

(51) Int. Cl. G06Q 20/22; G06Q 20/32; G06Q 30/02; G06Q 40/02

(52) U.S. Cl. CPC G06Q 20/22; G06Q 40/02; G06Q 30/0207; G06Q 20/3255

(57) ABSTRACT

A method of receiving a debt payment comprising sending a message to a debtor mobile computing device comprising a link to a debtor portal; displaying on the debtor mobile computing device an indication of the debt owing; displaying on the debtor mobile computing device a proposed payment plan for settlement of the debt; and receiving an indication that the debtor accepts the proposed payment plan is disclosed. The message sent may be a SMS message and it may include a indication, of the debt owing. The method may further comprise offering a discount to the debtor if the discounted amount is paid that day. The offer of a discount may initiate an automated negotiation process with the debtor.

### FIELD OF THE INVENTION

The present invention relates to a method and system for receiving a debt payment. More particularly, the invention relates to a method and system for receiving a debt payment which provides one or more gamification element which thereby provides a positive interface that assists individuals in paying their debts.

### BACKGROUND TO THE INVENTION

The majority of debt and arrears, collections by various providers, including bank and non-bank lenders, credit card providers, services and utilities companies, telecommunications and any business or person providing business or consumer invoicing or business invoking accounts, are currently undertaken by outsourcing to third party collectors, with lenders forfeiting around 40% of the amount owing to collection agencies in order to collect the debt. In 2014 alone, debt collection agencies in Australia recovered approximately $2.2bn in debts, costing lenders or debtors $880m in revenues.

By contrast, a digital approach allows vastly more efficient communications. The market for such products continues to grow, as volumes of small and medium loans to borrowers have increased over the past two decades. As such, several providers have expressed a significant interest in a digital service to improve efficiency in communication with, and collection of debts from, borrowers consumers and businesses.

The debt collection process is not often viewed as a driver of customer satisfaction. The reality of talking to debtors in difficult situations, coupled with tight regulations which includes state and federal regulations, coupled with internal processes, leads to numerous pitfalls that requires complicated navigation. For a variety of reasons around personal interactions concerning debt and emotion, often debtors are not willing to talk to a personal representative from the debtee or their agent. For this reason, there is a need for alternative business models and solutions which reflect the goals of informing consumers or businesses and reducing the incidence of misleading, unconscionable, and coercive tactics by collections departments or external agencies.

Accordingly, improved methods for paying debts and receiving these payments are required.

### SUMMARY OF THE INVENTION

The present invention is broadly directed to a debt payment method and system.

In a broad form the invention relates to a method and system for receiving a debt payment. In some forms, the present invention is of particular advantage by providing one or more gamification element which provides a positive interface that assists individuals in paying their debts.

In a first aspect, the present invention provides a method of receiving a debt payment comprising:

sending a message to a debtor mobile computing device comprising a link to a debtor portal;

displaying on the debtor mobile computing device an indication of the debt owing;

displaying on the debtor mobile computing device a proposed payment plan for settlement of the debt; and

receiving an indication that the debtor accepts the proposed payment plan.

The message sent may comprise a SMS message.

The message may further comprise an indication of the debt owing.

The method may further comprise the step of offering a discount to the debtor if the discounted amount is paid that day. The offer of a discount may initiate an automated negotiation process with the debtor. The automated negotiation process may comprise pre-set discount parameters. The present discount parameters may be modified to provide one or more additional payment incentive. The modification may comprise a limited time offer.

The method may further comprise a step of learning from debtor behaviour. The learning may comprise one or more of machine learning, behavioural analytics and a humanist approach.

The method may further comprise collecting behavioural data and using A/B testing to determine the most effective message to send to a debtor.

The method may further comprise storing data or metadata on debtor activity.

The method may further comprise one or more algorithm which collect data on user behaviour, and a suggestive analytics framework which takes this user data and determines the most effective communication strategy for debt recovery.

In a second aspect, the present invention provides a server based system for receiving a debt payment comprising:

a network connected messaging processor for sending a message to a debtor mobile computing device, the sent message comprising a link to a debtor portal;

a portal for displaying on the debtor mobile computing device an indication of the debt owing and for displaying on the debtor mobile computing device a proposed payment plan for settlement of the debt; and

a server adapted to interface with the debtor mobile computing device for receiving an indication that the debtor accepts the proposed payment plan.

The message sent by the processor may comprise a SMS message.

The message sent by the processor may further comprise an indication of the debt owing.

The portal may further offer a discount to the debtor if the discounted amount is paid that day. The offer of a discount may initiate an automated negotiation process with the debtor. The automated negotiation process may comprise pre-set discount parameters. The present discount parameters may be modified to provide one or more additional payment incentive. The modification may comprise a limited time offer.

The portal may further team from debtor behaviour. The learning may comprise one or more of machine learning, behavioural analytics and a humanist approach.

The portal may further collect behavioural data and use A/B testing to determine the most effective message to send to a debtor.

The system may further comprise one or more database to store data or metadata debtor activity.

The portal may further utilise one or more algorithm which collect data on user behaviour, and a suggestive analytics framework which takes this user data and determines the most effective communication strategy for debt recovery.

In a third aspect, the present invention provides a computer program product for receiving a debt payment, the computer program product comprising a computer usable medium and computer readable program code embodied on said computer usable medium, the computer readable code comprising: computer readable program code devices (i) configured to cause the computer to send a message to a debtor mobile computing device, the sent message comprising a link to a debtor portal;

computer readable program code devices (ii) configured to cause the computer to display on the debtor mobile computing device an indication of the debt owing and to display on the debtor mobile computing device a proposed payment plan for settlement of the debt; and

computer readable program code devices (iii) configured to cause the computer to receive an indication that the debtor accepts the proposed payment plan.

The message sent may comprise a SMS message.

The message sent may further comprise an indication of the debt owing.

The display may further comprise an offer of a discount to the debtor if the discounted amount is paid that day. The offer of a discount may initiate an automated negotiation process with the debtor. The automated negotiation process may comprise pre-set discount parameters. The present discount parameters may be modified to provide one or more additional payment incentive. The modification may comprise a limited time offer.

The computer program product may further comprise computer readable program cock devices (iv) configured to cause the computer to learn from debtor behaviour. The learning may comprise one or more of machine learning, behavioural analytics and a humanist approach.

The continuer program product may further comprise computer readable program code devices (v) configured to cause the computer to collect behavioural data and use A/B testing to determine the most effective message to send to a debtor.

The computer program product may further comprise computer readable program code devices (vi) configured to cause the computer to interface with one or more network connected database to store data or metadata on debtor activity.

The computer program product may further comprise computer readable program code devices (vii) configured to cause the computer to utilise one or more algorithm which collect data causer behaviour; and a suggestive analytics framework which takes this user data and determines the most effective communication strategy for debt recovery.

Any of the above aspects may be applied to any type of debtor. The type of debtor may comprise a non-bank debtor, a utility debtor, a telecom debtor, a personal loan debtor, a business loan debtor and a professional services debtor.

Where the terms “comprise”, comprises”, “comprising”, “include”, “includes”, “included” or “including” are used in this specification, they are to be interpreted as specifying the presence of the stated features, integers, steps or components referred to, but not to preclude the presence or addition of one or more other feature, integer, step, component or group thereof.

Further, any prior art reference or statement provided in the specification is not to be taken as an admission that such art constitutes, or is to be understood as constituting, part of the common general knowledge.

### BRIEF DESCRIPTION OF THE FIGURES

In order that the present invention may be readily understood and put into practical effect, reference will now be made to the accompanying illustrations, wherein like reference numerals refer to like features and wherein:

FIG. 1A shows a flowchart showing the steps according to one embodiment of the invention.

FIG. 1B shows a smartphone displaying one embodiment of a message sent according to the invention.

FIG. 1C shows the smartphone displaying one embodiment of the debtor portal according to the invention.

FIGS. 2A and 2B shows a graphical representation of one embodiment of a personal mobile computing device suitable for use with the invention.

FIG. 3 shows one example of an operator dashboard according to the invention.

### DETAILED DESCRIPTION OF THE INVENTION

The present invention relates to a method and system for receiving a debt payment. The method and system of the present invention find particular application in the pre-default stage of collections, which is between an overdue account being manually handled by providers and the use of any external collections agency.

Just one significant advantage of the present claimed invention is that it may be applied to any type of debtor. Just some examples of the type of debtor they may benefit from the present claimed invention are a non-bank debtor, a utility debtor, a telecom debtor, a personal loan debtor, a business loan debtor and a professional services debtor.

In one embodiment, the present invention is partly predicated on the present inventor's diligent study with has resulted in the discovery that application of a game interface provides a positive environment for a debtee which encourages them to pay their debts.

As will be evident from the below, the present invention provides the combination of a simple user experience and innovative communication algorithms which is of particular advantage because it provides a pleasant interface which allows debts to be settled in a non-confronting way.

The presently claimed invention takes advantage of the high success rate of digital communications by utilising SMS and email contact, and providing a debtor-facing web portal that gives debtors clear, simple information about what is owed and what options are available for repayment. This portal may make clear the debtor's legal rights and obligations, and provides the tools and information needed to manage and clear their overdue accounts.

As used herein “A/B testing” or “split testing” comprises comparing two versions of a web page such as, the debtor portal to see which one performs better. The two versions of the web page or debtor portal are shown to similar visitors or debtors. The one that gives a better performance such as, a better conversion rate, is implemented.

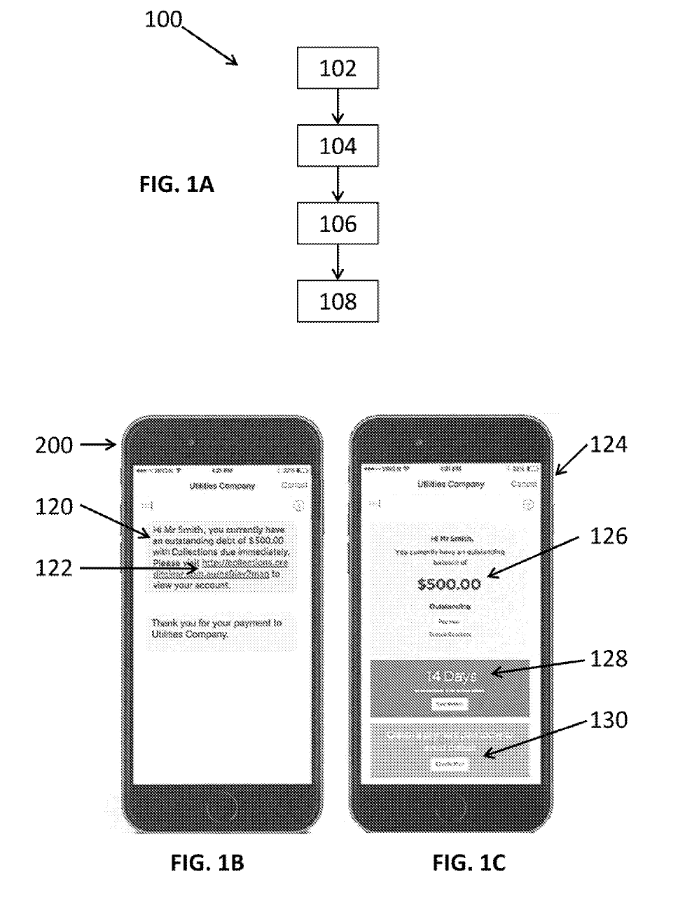

As shown in FIGS. 1A, 1B and 1C, in one embodiment the method 100 of the invention comprises the step 102 of sending a message 120 to a debtor mobile computing device 200. In the embodiment shown, message 120 comprises a SMS, which is of surprising advantage in payment compliance due to the efficacy of SMS communication.

As shown in FIG. 1B, message 120 may comprise a link 122 to a borrower-facing debtor portal 124 that is displayed on debtor mobile computing device 200. The borrow-facing debtor portal 124 may operate with minimal input required from lenders or debtees. In the embodiment shown, the link 122 comprises a hyperlink.

By pressing link 122, borrower-facing debtor portal 124 comprising an indication of the debt owing 126, the deadline for payment 128 and a button 130 to display proposed payment plan for settlement of the debt is displayed on debtor mobile computer device 200.

A debtor accepts the proposed payment plan by pressing an accept button 132 (not shown) displayed on debtor mobile computing device 200 and this acceptance is sent to and received server 291.

The method 100 may further comprise the step of offering a discount to the debtor if the discounted amount is paid that day. The offer of a discount may initiate an automated negotiation process with the debtor. The automated negotiation process may comprise pre-set discount parameters. The present discount parameters may be modified to provide one or more additional payment incentive. The modification may comprise a limited time offer.

In one embodiment, the method comprises a step of learning from debtor behaviour. The learning may comprise one or more of machine learning behavioural analytics and a humanist approach.

The method may further comprise collecting behavioural data and using A/B testing to determine the most effective message to send to a debtor

The method may further comprise storing data or metadata on debtor activity.

The method may further comprise one or more algorithm which collect data on user behaviour, and a suggestive analytics framework which takes this user data and determines the most effective communication strategy for debt.

The presently claimed invention may be of particular advantage by allowing borrower behaviour to be measured to identify behavioural trends, leading to data and insights on the most effective means of communicating with borrowers based on their behaviour and demographics.

The presently claimed invention is of surprising advantage because it makes use of a combination of learning algorithms and suggestive analytics. The method and system of the invention may be configured with pre-set ‘rules of engagement’, the method or system may automatically determine the moat effective method for reaching the debtee and contacts them for example, by email or SMS, with a link to the debtor portal. The borrower portal of the presently claimed invention is of particular advantage because it allows borrowers in straightforward cases to clear their debt without needing to speak with a collector, thereby freeing up lender resources to focus on more difficult cases. This is of surprising advantage because of its efficacy in attracting payment.

The presently claimed invention may also be an intelligent system, giving debtors the capability to collect and analyse data on their collections processes in order to take advantage of the opportunities for increasing efficiency that digital solutions provide. The presently claimed invention's debtor portal collects behavioural data and allows A/B testing to determine the most effective ways to contact borrowers. By basing decision strategy on machine teaming and borrower behaviour, the presently claimed invention may assist debtees find the fewest number of contact points with the highest recovery rate, minimising cost for the lender and nuisance to the borrower.

Improving the borrower's experience is a core part of the present invention. At present, a full third of all complaints about debt collection relate to harassment and coercion by collectors. As a compliance-driven and strictly regulated industry, it is unacceptable to have such a large volume of complaints be related to unscrupulous behaviour. To address this, the presently claimed invention complies with the relevant regulatory frameworks, ensuring contact with borrowers is compliant with regulations and applicable Codes. As such, the presently claimed invention prevents unscrupulous collectors from applying undue pressure to borrowers.

This highlights another advantage of the present invention, which is that it provides debtees with access to all the relevant information, and to ensure collections comply with regulations and industry guidance.

The present invention provides a service which simplifies and optimises the payment of outstanding accounts, through a simple to understand borrower portal. Through adjustable and pre-set rulesets, the portal 124 communicates with debtors holding arrears accounts with minimal handling required by the debtee. This scalable technology incorporates powerful analytical tools to provide debtees with insights into arrears accounts in order to further optimise their collections process.

Another advantage of the presently claimed invention is that it allows debtors to be able to quickly assess their obligations and easily address them, as they typically wish to end their involvement as quickly as possible. They typically desire more flexibility in responding as time allows, and to be contacted by automated message.

The present inventor has developed a method and system that gives lenders the tools to simply, efficiently and effectively manage their overdue accounts. With its strong focus on analytics and increased debtor satisfaction and control, the data driven approach of the present invention decreases both delimit rates and the cost of collections, benefiting both lenders and borrowers.

In one embodiment, the present invention is a cloud-based software-as-a-service solution which provides debtees with information and options to take action through an easy to understand web portal. This may be coupled this with a set of real-time analytics tools for debtees designed to analyse borrower behaviour and draw from existing accounting and loan management systems, in order to identify the most efficient and effective means for communicating with customers.

In another embodiment, the present invention provides algorithmic learning capabilities which help analyse specific data to enhance a debtee's ability to make informed decisions on the type of credit offered to borrowers, and to identify borrower risk profiles.

In a particular embodiment, the present invention is used in the pre-default area of collections, with the core focus of activity being early stage reminders to prompt payments through a cloud-based portal.

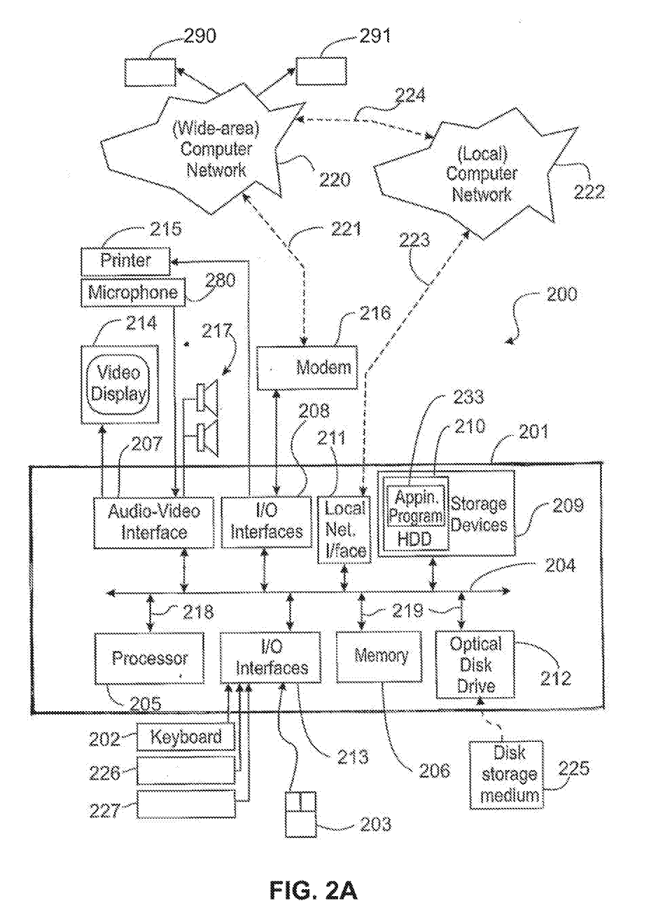

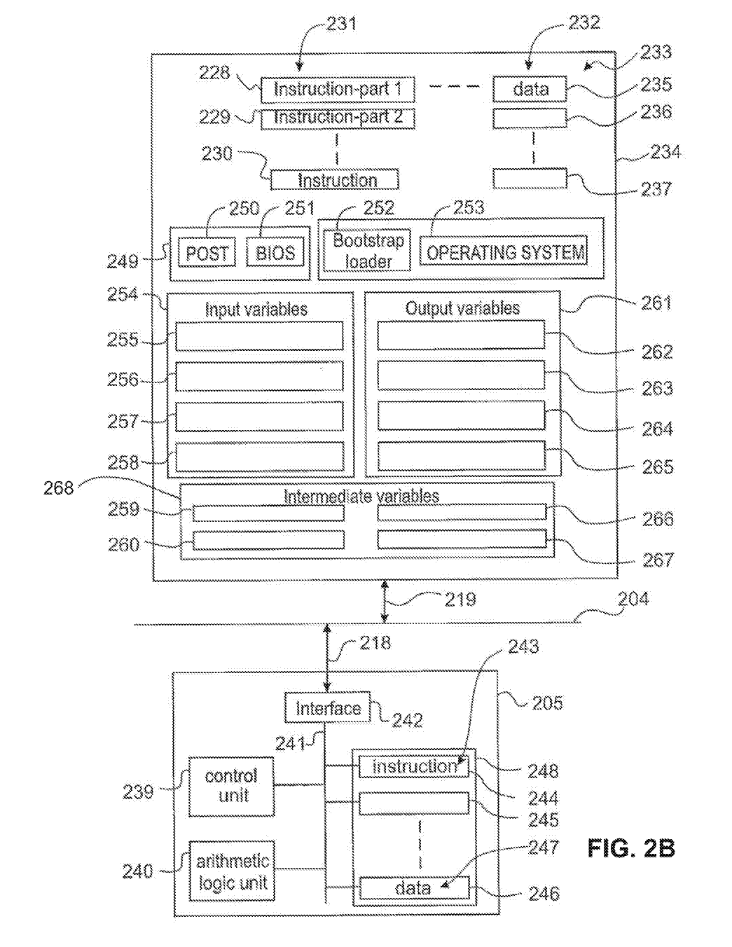

One embodiment of a debtor mobile computing device 200 suitable for use in the present invention is shown in FIGS. 2A and 2B. In the embodiment shown debtor mobile commuting device 200 comprises a computer module 201 comprising input devices such as a keyboard 202, a mouse pointer device 203, a scanner 226, a camera 281, an external hard drive 227, a touchscreen video display 214 and a microphone 280; and output devices including a printer 215, the touchscreen video display device 214 and loudspeakers 217. In some embodiments video display 214 may comprise a touchscreen.

A Modulator-Demodulator (Modem) transceiver device 216 may be used by the computer module 201 for communicating to and from a communications network 220 via a connection 221. The network 220 may be a wide-area network (WAN), such as the Internet, a cellular telecommunications network, or a private WAN. Through the network 220, computer, module 201 may be connected to; and may have system interaction 293 with; other similar personal mobile computing devices 290 or server computers 292. Where the connection 221 is a telephone line, the modern 216 may be a traditional “dial-up” modem. Alternatively, where the connection 221 is a high capacity (e.g.: cable) connection, the modem 216 may be a broadband modem. A wireless modem may also be used for wireless connection to network 220.

The computer module 201 typically includes at least one processor 205, and a memory 206 for example formed from semiconductor random access memory (RAM) and semiconductor read only memory (ROM). The module 201 also includes a number of input/output (I/O) interfaces including: an audio-video interface 207 that couples to the touchscreen video display 214, loudspeakers 217 and microphone 280; an I/O interface 213 for the keyboard 202, mouse 203, scanner 226 and external hard drive 227; and an interface 208 for the external modem 216 and printer 215. In some implementations, modem 216 may be incorporated within the computer module 201, for example within the interface 208. The computer module 201 also has a local network interface 211 which, via a connection 223, permits coupling of the debtor mobile computing device 200 to a local computer network 222, known as a Local Area Network (LAN).

As also illustrated, the local network 222 may also couple to the wide network 220 via a connection 224, which would typically include a so-called “firewall” device or device of similar functionality. The interface 211 may be formed by an Ethernet circuit card, a Bluetooth wireless arrangement or an IEEE 802.11 wireless arrangement, a Near Field Communication, NFC, arrangement or other suitable interface.

The I/O interfaces 208 and 213 may afford either or both of serial and parallel connectivity, the former typically being implemented according to the Universal Serial Bus (USB) standards and having corresponding USB connectors (not illustrated).

Storage devices 209 are provided and typically include a hard disk drive (HDD) 210. Other storage devices such as, an external HD 227, a disk drive (not shown) and a magnetic tape drive (not shown) may also be used. An optical disk drive 212 is typically provided to act as a non-volatile source of data. Portable memory devices, such as optical disks (e.g.: CD-ROM, DVD, Blu-Ray Disc), USB-RAM, external hard drives and floppy disks for example, may be used as appropriate sources of data to the debtor mobile computing device 200. Another source of data to debtor mobile computing device 200 is provided by the at least one server computer 292 through network 220.

The components 205 to 213 of the computer module 201 typically communicate via an interconnected bus 204 in a manner which results in a conventional mode of operation of debtor mobile computing device 200. In the embodiment shown in FIGS. 2A and 2B, processor 205 is coupled to system bus 204 through connections 218. Similarly, memory 206 and optical disk drive 212 are coupled to the system bus 204 by connections 219. Examples of a debtor mobile computing device 200 on which the described arrangements can be practiced include smart phones; tablet computers, gaming consoles, media players, TVs, wearable devices such as watches and glasses or a like device comprising a computer module like computer module 201. It is to be understood that when debtor mobile computing device 200 comprises a smart phone or a tablet computer some illustrated input and output devices may not be included such as, mouse pointer device 201; keyboard 202; scanner 226; and printer 215.

FIG. 2B is a detailed schematic block diagram of processor 205 and a memory 234. The memory 234 represents a logical aggregation of all the memory modules, including the storage device 209 and semiconductor memory 206, which can be accessed by the computer module 201 in FIG. 2A.

The methods of the invention may be implemented using debtor mobile computing device 200 wherein the methods may be implemented as one or more software application programs 233 executable within computer module 201. In particular, the steps of the methods of the invention may be effected by instructions 231 in the software carried out within the computer module 201.

The software instructions 231 may be formed as one or more code modules, each for performing one or more particular tasks. The software 233 may also be divided into two separate parts, in which a first part and the corresponding code module performs the method of the invention and a second part and the corresponding code modules manage a graphical user interface between the first part and the user.

The software 233 may be stored in a computer readable medium, including in a storage device of a type described herein. The software may loaded into the debtor mobile computing device 200 from the computer readable medium or through network 221 or 223, and then executed by debtor mobile computing device 200. In one example, the software 233 is stored on storage medium 225 that is read by optical disk drive 212. In another embodiment, the software 233 is stored in a server computer or cloud 291 and accessed by debtor mobile computing device 200. When software 233 is stored in debtor mobile computer device 200, typically it is stored in the HDD 210 or the memory 206.

A computer readable medium having such software 233 or computer program recorded on it is a computer program product. The use of the computer program product in the debtor mobile computing device 200 preferably effects a device or apparatus for implementing the methods of the invention.

In some instances, the software application programs 233 may be supplied to the user encoded on one or more disk storage medium 225 such as a CD-ROM, DVD or Blu-Ray disc, and read via the corresponding drive 212, or alternatively may be read by the user from the networks 220 or 222. Still further, the software can also be loaded into the debtor mobile computing device 200 from other computer readable media. Computer readable storage media refers to any non-transitory tangible storage medium that provides recorded instructions and/or data to the computer module 201 or debtor mobile computing device 200 for execution and/or processing. Examples of such storage media include floppy disks, magnetic tape, CD-ROM, DVD, Blu-ray Disc, a hard disk drive, a ROM or integrated circuit, USB memory, a magneto-optical disk, or a computer readable card such as a PCMCIA card and the like, whether or not such devices are internal or external of the computer module 201. Examples of transitory or non-tangible computer readable transmission media that may also participate in the provision of software application programs 233, instructions 231 and/or data to the computer module 201 include radio or infra-red transmission channels as well as a network connection 221, 223, 334, to another computer or networked device such as, server 291 and the Internet or an Intranet including transmissions and information recorded on Websites and the like.

The second part of the application programs 233 and the corresponding code modules mentioned above may be executed to implement one or more graphical user interfaces (GUIs) to be rendered or otherwise represented upon display 214. Through manipulation of, typically, touchscreen 214 a user of debtor mobile computing device 200 and the methods of the invention may manipulate the interface in a functionally adaptable manner to provide controlling commands and/or input to the applications associated with the GUI(s). Other forms of functionally adaptable user interfaces may also be implemented, such as an audio interface utilizing speech prompts output via loudspeakers 217 and user voice commands input via microphone 280. The manipulations including screen touches, speech prompts, device movement gestures and/or user voice commands may be transmitted via network 220 or 222.

When the computer module 201 is initially powered up, a power-on self-test (POST) program 250 may execute. The POST program 250 is typically stored in a ROM 249 of the semiconductor memory 206. A hardware device such as the ROM 249 is sometimes referred to as firmware. The POST program 250 examines hardware within the computer module 201 to ensure proper functioning, and typically cheeks processor 205, memory 234 (209, 206), and a basic input-output systems software (BIOS) module 251, also typically stored in ROM 249, for correct operation. Once the POST program 250 has run successfully, BIOS 251 activates hard disk drive 210. Activation of hard disk drive 210 causes a bootstrap loader program 252 that is resident on hard disk drive 210 to execute via processor 205. This loads an operating system 253 into RAM memory 206 upon which operating system 253 commences operation. Operating system 253 is a system level application, executable by processor 205, to fulfil various high level functions, including processor management, memory management, device management; storage management, software application interface, and generic user interface.

Operating system 253 manages memory 234 (209, 206) in order to ensure that each process or application running on computer module 201 has sufficient memory in which to execute without colliding with memory allocated to another process. Furthermore, the different types of memory available in the debtor mobile computing device 200 must be used properly so that each process can run effectively. Accordingly, the aggregated memory 234 is not intended to illustrate how particular segments of memory are allocated, but rather to provide a general view of the memory accessible by computer module 201 and how such is used.

Processor 205 includes a number of functional modules including a control unit 239, an arithmetic logic unit (ALU) 240, and a local or internal memory 248, sometimes called a cache memory. The cache memory 248 typically includes a number of storage registers 244, 245, 246 in a register section storing data 247. One or more internal busses 241 functionally interconnect these functional modules. The processor 205 typically also has one or more interfaces 242 for communicating with external devices via the system bus 204, using a connection 218. The memory 234 is connected to the bus 204 by connection 219.

Application program 233 includes a sequence of instructions 231 that may include conditional branch and loop instructions. Program 233 may also comprise data 232 which is used in execution of the program 233. The instructions 231 and the data 232 are stored in memory locations 228, 229, 230 and 235, 236, 237, respectively. Depending upon the relative size of the instructions 231 and the memory locations 228-230, a particular instruction may be stored in a single memory location as depicted by the instruction shown in the memory location 230. Alternately, an instruction maybe segmented into a number of parts each of which is stored in a separate memory location, as depicted by the instruction segments shown in the memory locations 228 and 229.

In general, processor 205 is given a set of instructions 243 which are executed therein. The processor 205 then waits for a subsequent input, to which processor 205 reads by executing another set of instructions. Each input may be provided from one or more of a number of sources, including data generated by one or more of the input devices 202, 203, or 214 when comprising a touchscreen, data received from an external source across one of the networks 220, 222, data retrieved from one of the storage devices 206, 209 or data retrieved from a storage medium 225 inserted into the corresponding reader 212. The execution of a set of the instructions may in some cases result in output of data. Execution may also involve storing data or variables to the memory 234.

The disclosed arrangements use input variables 254 that are stored in the memory 234 in corresponding memory locations 255, 256, 257, 258. The described arrangements produce output variables 261 that are stored in the memory 234 in corresponding memory locations 262, 263, 264, 265. Intermediate variables 268 may be stored in memory locations 259, 260, 266 and 267.

The register section 244, 245, 246, the arithmetic logic unit (ALU) 240, and the control unit 239 of the processor 205 work together to perform sequences of micro-operations needed to perform decode, and “execute” cycles for every instruction in the instruction set making up the program 233. Each fetch, decode, and execute cycle comprises:

(a) a fetch operation, which fetches or reads an instruction 231 from memory location 228, 229, 230;

(b) a decode operation in which control unit 239 determines which instruction has been fetched; and

(c) an execute operation in which the control unit 239 and/or the ALU 240 execute the instruction.

Thereafter, a further fetch, decode, and execute cycle for the next instruction may be executed. Similarly, a store cycle may be performed by which the control unit 239 stares or writes a value to a memory locution 232.

Each step or sub-process in the methods of the invention may be associated with one or more segments of the program 233, and may be performed by register section 244-246, the ALU 240, and the control unit 239 in the processor 205 working together to perform the fetch, decode, and execute cycles for every instruction in the instruction seller the noted segments of program 233.

One or more other debtor mobile computer device 290 may be connected to the communications network 220 as seen in FIG. 1A. Each such debtor mobile computer device 290 may have a similar configuration to debtor mobile computer device 200 comprising a computer module 201 and corresponding peripherals.

One or more other server computer 291 may be connected to the communications network 220. These server computers 291 respond to requests from debtor mobile computing device 200, 290 or other server computers (not shown) to provide information. Each server computer 291 may comprise or be associated with one or more database 292 (not shown).

The methods of the invention may alternatively be implemented in dedicated hardware such as one or more integrated circuits performing the functions or sub functions of the described methods. Such dedicated hardware may include graphic processors, digital signal processors, or one or more microprocessors and associated memories.

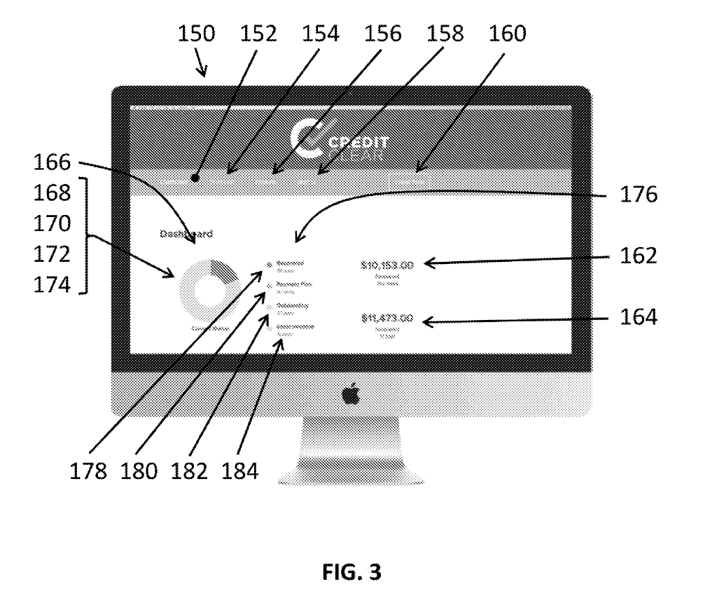

One embodiment of an operator dashboard 150 according to the invention is shown in FIG. 3. The operator dashboard 150 comprises menu bar 152 which is shown to comprise buttons such as, dashboard button 154, accounts button 156, settings button 156 and upload debts button 160. Also shown on dashboard 150 are recovered debts time frame display 162 and recovered debts total display 164.

Dashboard 150 further comprises a current status graphical display 166 and a current status numerical display 176. The current status graphical display 166 comprises recovered debts graphical display 168, payment plan graphical display 170, outstanding debts graphical display 172 and unrecoverable debts graphical display 174. The current status numerical display 176 comprises recovered debts numerical display 178, payment plan numerical display 180, outstanding debts numerical display 182 and unrecoverable debts numerical display 184.

The present invention is likely to find immediate application due to the high penetration of online banking in some markets and the large potential for application in markets where online penetration will increase, for example, the US and UK penetration rates are expected to rise from 60-70% towards 100%.

The present invention optimises the process of overdue account collection and the relationship between debtors and debtees.

Borrowers are frequently harassed over unintentional debts, many of which are simple oversights. The presently claimed invention addresses this by providing simple, straightforward ways for borrowers to keep track of what they owe. By focusing on a time saving, less confrontational, and easy to use self-management portal, borrower satisfaction may be increased and in turn the percentage of successful payments is increased. Another significant advantage of the present invention is that the automated method and system can not be baited or biased when dealing with debtors.

Throughout the specification the aim has been to describe the preferred embodiments of the invention without limiting the invention to any one embodiment or specific collection of features. It will therefore be appreciated by those of skill in the art that, in light of the instant disclosure, various modifications and changes can be made in the particular embodiments exemplified without departing from the scope of the present invention.

1. A method of receiving a debt payment comprising:
sending a message to a debtor computing device comprising a link to a debtor portal;
displaying on the debtor computing device an indication of the debt owing;
displaying on the debtor computing device a proposed payment plan for settlement of the debt;
receiving an indication that the debtor accepts the proposed payment plan;
collecting behavioural data and using testing to determine the most effective message to send to a debtor;
using real-time analytics to analyse debtor behaviour to identify the most efficient and effective communication with debtors; and
receiving the debt payment.

2. The method of claim 1, wherein the message sent comprises an electronic message.

3. The method of claim 1, wherein the message further comprises an indication of the debt owing.

4. The method of claim 1 further comprising the step of offering a discount to the debtor if the discounted amount is paid within a limited time.

5. The method of claim 4, wherein the offer of a discount initiates an automated negotiation process with the debtor.

6. The method of claim 1 further comprising a step of learning from debtor behaviour.

7. The method of claim 1 further comprising one or more algorithm which collect data on debtor behaviour, and a suggestive analytics framework which takes this debtor data and identifies the most efficient and effective communication for debt recovery.

8. The method of claim 1 wherein the payment is received through the debtor portal.

9. (canceled)

10. The method of claim 1 further comprising using algorithmic learning to inform decisions on the type of credit offered to a debtor and/or to identify a debtor risk profile.

11. A server based system for receiving a debt payment comprising:
a network connected messaging processor for sending a message to a debtor computing device, the sent message comprising a link to a debtor portal;
a portal for displaying on the debtor computing device an indication of the debt owing and for displaying on the debtor computing device a proposed payment plan for settlement of the debt;
a server adapted to interface with the debtor computing device for receiving an indication that the debtor accepts the proposed payment plan;
the portal collecting behavioural data and using testing to determine the most effective message to send to a debtor;
using real-time analytics to analyse debtor behaviour to identify the most efficient and effective communication with customers; and
the system receiving the debt payment.

12. The server based system of claim 11, wherein the message sent by the processor comprises an electronic message.

13. The server based system of claim 11, wherein the message sent by the processor further comprises an indication of the debt owing.

14. The server based system according to claim 11, wherein the portal further offers a discount to the debtor if the discounted amount is paid within a limited time.

15-21. (canceled)

22. A computer program product for receiving a debt payment, the computer program product comprising a computer usable medium and computer readable program code embodied on said computer usable medium, the computer readable code comprising: computer readable program code devices (i) configured to cause the computer to send a message to a debtor computing device, the sent message comprising a link to a debtor portal;
computer readable program code devices (ii) configured to cause the computer to display on the debtor computing device an indication of the debt owing and to display on the debtor computing device a proposed payment plan for settlement of the debt; and
computer readable program code devices (iii) configured to cause the computer to receive an indication that the debtor accepts the proposed payment plan;
computer readable program code devices (v) configured to cause the computer to collect behavioural data and use testing to determine the most effective message to send to a debtor;
computer readable program code devices (v) configured to cause the computer to receive the debt payment.

23. The computer program product of claim 22, wherein the message sent comprises an electronic message.

24. The computer program product of claim 22, wherein the message sent further comprises an indication of the debt owing.

25-26. (canceled)

27. The method of claim 1 wherein the testing comprises testing to determine the most effective ways to contact a debtor.

28. The method of claim 27 wherein the testing comprises multivariate testing.

29. The method of claim 28 wherein the testing comprises A/B testing or split testing.

30. The method of claim 2 wherein the electronic message comprises one or more of an SMS, an RCS or an Email message.
